(19) United States
(12) Patent Application Publication
(10) Pub. No.: US 2010/0119798 A1
(43) Pub. Date: May 13, 2010

(54) PLASTIC MOLDED PART AND THE PRODUCTION THEREOF

(75) Inventors: Martin Kirschbaum, Waiblingen (DE); Evangelos Konstantinidis, Urbach (DE); Stefanie Brenner, Fellbach (DE); Mathias Pahl, Schorndorf (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: SCHEER SURFACE SOLUTIONS GMBH, Lorch (DE)

(21) Appl. No.: 12/594,620

(22) PCT Filed: Apr. 5, 2008
(86) PCT No.: PCT/EP2008/002722

§ 371 Date: Oct. 5, 2009

(30) Foreign Application Priority Data
Apr. 5, 2007 (DE) 10 2007 017 978.4

(51) Int. Cl. B32B 5/16; B29C 39/38

(52) U.S. Cl. 428/220; 264/299; 264/322

(57) ABSTRACT

A process for producing plastics moldings including forming a molding from a castable reactive composition including at least one organic polymer component and at least one inorganic filler, wherein the average particle size of the filler is <150 μm and the proportion of the inorganic filler present in the reactive composition is >50% by weight, based on the weight of the hardened molding; hardening the molding; and, after hardening, subjecting the molding to a forming process.

### RELATED APPLICATIONS

This is a §371 of International Application No. PCT/EP2008/002,722, with an international filing date of Apr. 5; 2008 (WO 2008/122428 A1, published Oct. 16, 2008), which is based on German Patent Application No. 10 2007 017 978.4, filed Apr. 5, 2007.

### TECHNICAL FIELD

This disclosure relates to a process for the production of plastics moldings, preferably for the kitchen sector, sanitary sector and trade-fair sector, to a reactive composition for the production of plastics moldings, and also to plastics moldings which can be, or have been, produced by the process and/or from the reactive composition.

### BACKGROUND

Molded plastics panels can by way of example, be used as interior fittings, in particular in the kitchen sector or in the sanitary sector, and also in commercial construction, in shopfitting and in trade-fair construction work. In those applications, the moldings are in particular used as floor panels, wall panels or worktops. As a function of the particular application sector, the moldings differ in their shape, in their dimensions, and also in their constitution.

These moldings generally have an organic polymer matrix in which inorganic and/or organic fillers have been dispersed. The polymer matrix can by way of example be formed from polyester resins or polyacrylic resins. The inorganic fillers generally used are flours, sand or powders. Quartz and cristobalite can in particular be used.

Known molded plastics panels are generally cast from a reactive composition and then hardened. By way of example, the reactive composition can be cast into temperature-regulated pressurized molds and hardened with temperature increase and pressure. As disclosed in EP 851 808, this method can also be used to produce moldings of composite structure. EP '808 describes an integral panel component of multilayer structure.

Known plastics moldings can comprise lamellar materials in a desired preferential orientation to make them easier to clean and more resistant to scratching. DE 40 40 602 discloses a reactive composition which can be used to produce moldings of this type and which comprises not only a particulate filler with particle size distribution from 0 to 200 μm, but also an Iriodin dye which takes the form of lamellae with particle size of from 30 μm to 200 μm.

Known processes for production of these molded plastics panels are very similar. After casting and hardening, the plastics moldings can be ground and polished, and then generally cut to size with precise dimensions. They are usually used or installed on customers' premises in this form without further mechanical operations or further processing. Any adaptation that may be required has to take place mechanically, for example, via cutting to size or sawing to size. The cut-to-size plastics panels are then installed as required by their intended function, for example, as a kitchen worktop.

Specific connection profiles are generally used to connect the plastics parts to walls or furniture. However, small gaps and grooves can arise between the plastics moldings and profiles. These have to be sealed by complicated methods so that they do not collect dirt and bacteria, for example.

It would therefore be desirable that molded plastics panels were available which can be adapted easily and individually to their intended location while preferably also providing the possibility of gap-free connections. These plastics moldings could thus comprise a high proportion of filler, with maximum uniformity of distribution of the filler within the plastics moldings.

### SUMMARY

We provide a process for producing plastics moldings including forming a molding from a castable reactive composition including at least one organic polymer component and at lest one inorganic filler, wherein the average particle size of the filler is <150 μm and the proportion of the inorganic filler present in the reactive composition is >50% by weight, based on the weight of the hardened molding; hardening the molding; and, after hardening, subjecting the molding to a forming process.

We also provide a reactive composition used in the process, wherein the at least one inorganic filler has an average particle size of <30 μm.

We further provide a plastics melding including a polymer matrix into which at least one inorganic filler has been embedded with uniform distribution produced by the process.

### DETAILED DESCRIPTION

The process is suitable for the production of plastics moldings, in particular for the production of plastics moldings which are in essence panels. A process is particularly suitable for the production of worktops, wall panels and floor panels which are used in the kitchen sector, sanitary sector and trade-fair sector.

The process uses a castable reactive composition to manufacture and harden a molding which is, preferably a panel. After hardening, the molding is subjected to a forming process. This castable reactive composition comprises at least one organic polymer component and at least one inorganic filler, preferably one particulate inorganic filler. The average particle size of the at least one filler is smaller than 150 μm, preferably smaller than 100 μm, in particular smaller than 50 μm, particularly preferably smaller than 30 μm. Within the last-mentioned range, particle sizes from 5 μm to 10 μm are particularly preferred. The proportion of the inorganic filler present in the reactive composition is >50% by weight (based on the weight of the hardened molding).

For the manufacture of the molding which, is preferably a panel, the reactive composition is transferred, in particular cast, into a mold, and then hardened. The reactive composition can in particular be transferred into a heatable compression mold. The reactive composition can be heated prior to transfer to the mold, for example, to a temperature of about 50° C. Once the material has been charged toy the mold, the mold can be relatively rapidly heated to a particular hardening temperature, for example, about 100° C. Hardening of the reactive composition may be promoted via increased pressure in the compression mold.

After hardening, the above-mentioned forming process is carried out on the molding. To this end it is preferable that at least one sub-region of the hardened molding is heated, in particular to temperatures above the T_{g} value of the at least one organic polymer component, preferably to at least 100° C. The plastics molding becomes formable through introduction of energy, and can be subjected to a change of shape, in particular a plastic change of shape. Once the respective molding has been cooled, it retains its new shape. The process is preferably reversible.

The forming, process may be carried out at a temperature which is below the temperature at which the molding could melt or decompose.

It is particularly preferable that, for the forming process, the hardened molding is heated to a temperature of from 100° C. to 250° C., preferably from 100° C. to 200° C., in particular from 120° C. to 160° C.

Surprisingly, it has been found that the plastics moldings produced from the above-mentioned reactive composition can still readily undergo a forming process-after they have been hardened and, in particular, have very good suitability for thermoforming, despite the relatively high proportion of filler. The reason for this appears to lie in the materials used and in the interactions between them. The low average particle size of the inorganic filler is believed to be a particularly significant factor. This appears to ensure that when heating occurs the temperature distribution within the interior of the molding is relatively uniform. There is also a great reduction in the risk that large stresses arise within the molding. The surface of the molding remains in essence free from cracks during the forming process, and there are generally no cracks of any type discernible by the naked eye. All that is necessary after the forming process is at most a brief surface-grinding process, but the plastics part can mostly be used directly after the forming process, without further mechanical operations.

It is particularly preferable that the reactive composition is free from inorganic filler particles of size >250 μm. It preferably comprises exclusively inorganic filler particles of size <100 μm, in particular <50 μm (although the production process sometimes makes it impossible to avoid traces of coarser particles, the proportion of which is however always below 5%, preferably below 1%, in each case based on the total amount of filler particles).

It is preferable that the reactive composition comprises filler particles in monomodal distribution, but preference can also be given to bimodal or trimodal distributions.

The reactive composition may comprise only the inorganic filler particles and no other fillers such as the organic fillers mentioned in the introduction.

It is preferable that the reactive composition consists essentially of the at least one organic polymer component and of the at least one inorganic filler, and that the only materials present alongside these are one or more colorants and/or auxiliaries. Among the latter are in particular crosslinking agents, release agents, polymerization catalysts (e.g., peroxides), rheology aids and dispersing agents, small amounts of which can be present. The auxiliaries serve in particular to improve the chemical and/or, mechanical properties of the reactive composition, and the additions of these can be matched to the requirements of particular applications. Some suitable colorants and auxiliaries are described in more detail at a later stage below.

The reactive composition may comprise, as a rheology aid, a silanized or non-silanized silica. The rheology aid is effective in retarding or indeed entirely preventing sedimentation of the at least one inorganic filler within the reactive composition prior to hardening. Specifically, in particular in the case of low-viscosity reactive compositions, non-uniform distribution of the filler can otherwise arise within the intended molding, and this can adversely affect its properties.

The viscosity of the reactive composition is preferably in the range from 5 Pa·s to 60 Pa·s, preferably from 15 Pas to 45 Pas, in particular front 20 Pa·s to 30 Pa·s (in each case at 20° C.). The viscosity is in essence determined by the proportion of filler in the reactive composition, but can also be affected by the auxiliaries mentioned.

It is preferable that, for the forming process, the hardened molding is heated by means of hot air. By way of example, in one possible method for the process, air is heated via one or more air-heating devices and is targeted onto the molding with the aim of heating one or more particular sites thereon and undertaking a local forming process. However, the molding can in principle be heated by any known fluid, and can therefore also be heated, by liquids, as long as the use of these does not damage the plastics molding.

Another possible method uses radiation to heat the molding, for example, by using radiation in the infrared region or in the microwave region.

It is particularly preferable that, for the forming process, the hardened molding is heated in a heated press.

The forming process carried out on the hardened plastics molding can use any of the industrial forming processes, in particular, those suitable for thermoforming. Particular processes that can be used are forming processes that use tension or pressure, e.g., thermoforming processes or bending processes.

Because, as described above, the plastics moldings produced from the castable reactive composition have the property of formability, the process can be used to produce molded plastics panels which can be individually adapted to their intended location by using a forming process. By way of example, the edge of a plastics molding intended as kitchen worktop can along a wall, be particularly advantageously subjected to an upwards forming process, if appropriate carried out in situ. No gap therefore arises in the plane of the working surface. It is sometimes possible to omit any separate connection profile for sealing, the connection to the wall. The process can also be used particularly easily to produce shower trays.

The process can also be particularly effective in producing one-piece plastics Moldings which have one or more depressions in the form of a valley or trough. The one-piece plastics moldings may take the form of a trough or basin. To this end, for example, a sheet can be cast and then subjected to a thermoforming process, thus forming the depression or depressions.

The process can produce individually shaped plastics moldings which can be installed immediately. As an alternative, it is also possible to delay the forming-process step to a subsequent juncture, for example to delay it until the materials are at the customer's premises.

The castable reactive composition may comprise an acrylic- and/or methacrylic-based organic polymer component, in particular, a synthetic resin on that basis. Particular preference is given to methacrylate systems. The organic polymer component can comprise suitable monomers and also, if appropriate, prepolymers. In the event of polymerization of the methacrylate system, it is possible to use further monomers in the form of alkyl or aryl methacrylates, to form copolymers. By way of example, copolymers can be formed with ethyl methacrylate or with butyl methacrylate.

The castable reactive composition may comprise polymethyl methacrylate (PMMA) as organic polymer component.

Alongside PMMA, it is possible to use further organic polymers selected from a wide range of various plastics to form the polymer matrix. Examples that may be mentioned are polyester resins, polyacrylic resins and polyvinyl ester resins, and also polyurethane resins or epoxy resins. The type of reaction that proceeds during formation of the polymers is not in principle of any decisive importance for the process, examples being free-radical, anionic or cationic polymerization.

The castable reactive composition may comprise methyl methacrylate (MMA) as organic polymer component.

The castability of the reactive composition can be determined via the ratio of the reactants to one another, for example via the ratio of PMMA to MMA, if both are present in the reactive composition. In the case of acrylic resins, a proportion of PMMA dissolved in MMA inhibits sedimentation of the filler particles during handling of the reactive composition. Other known substances can also be used for this purpose, however, examples being fine-particle-silica, which of course has been mentioned above.

This is a useful point to provide, as indicated above, a description of some suitable auxiliaries and colorants.

Crosslinking agents can be added to the castable reactive composition to increase the chemical and mechanical stability of the end product. Those skilled in the art are aware of suitable crosslinking agents. Crosslinking agents preferably used are di- or polyfunctional monomers and/or polymers, in particular di- or polyfunctional acrylates or dimethacrylates, for example, ethylene glycol dimethacrylate, trimethylolpropane trimethacrylate or pentaerythritol triacrylate.

Stabilizers can, in particular, be added to the castable reactive, composition in addition to; or instead of, the crosslinking agents. Stabilizers serve to improve the chemical properties of the organic polymer components. They increase the lifetime of the polymers and protect them from damaging effects, such as oxidation, radiation and heat which can arise in the application sector. In particular, addition of antioxidants and/or UV stabilizers inhibits oxidation and decomposition and/or continued crosslinking of polymer chains. Compounds that can be used for this purpose are phenols, amines or phosphanes.

Colorants means not only dyes, in particular, organic dyes, but also pigments. Colorants preferably added to the castable reactive composition are pigments, since with organic dyes there is the risk that these undergo alteration during or after manufacture of the moldings, and are not then colorfast. It is therefore, in particular, inorganic pigments that have particular importance. Particular colorants that can be used are therefore TiO₂, iron oxide, carbon black, cobalt blue or ultramarine blue, or else chromium green. The composition can also use what are known as special-effect pigments, an example being strontium aluminates which have been doped with rare earths and which exhibit intensive phosphorescence. The colorants can, as a function of the application, have uniform or non-uniform distribution in the plastics molding.

It is also possible that external and/or internal plasticizers are present in the reactive composition to reduce the brittleness; hardness and softening point of the polymers, and thus improve the formability described. Those skilled in the art are aware of examples of suitable plasticizers, e.g., phthalic esters (an external plasticizer) or long-chain acrylates (an internal plasticizer).

Release agents can be added to the reactive composition to improve release of the hardened molding from the mold. Those skilled in the art are aware of suitable release agents, e.g., stearic acid.

The above-mentioned at least one inorganic filler is preferably a fine-particle inorganic filler, in particular, a filler obtainable as natural product. By way of example, crystalline quartz sand is produced as by-product during kaolin extraction.

The at least one inorganic filler may be selected from the group consisting of quartz, cristobalite, tridymite, corundum and mixtures thereof. Among these, preference is given to quartz and cristobalite.

The at least one inorganic filler can also comprise, as further materials, materials such as glass, aluminum oxide, ground granite, ground basalt, and ceramic materials, in particular, silicon nitride and/or silicon carbide.

It can also be preferable that the at least one inorganic filler that can be used comprises surface-coated filler particles. The surfaces of the filler particles can therefore have been silanized to ensure particularly good binding to at least one organic polymer component.

It is preferable that the Mohs hardness of the at least one inorganic filler is greater than or equal to 4, in particular, from 5 to 9.

The proportion of the at least one inorganic filler present in the reactive composition may be from 50% by weight to 85% by weight, in particular, froth about, 60% by weight to 70% by weight, based on the weight of the hardened molding. It is preferable to maximize the proportion of filler.

Reaction compositions which have proven particularly suitable are those which comprise, as constituents, at least one organic polymer component and at least one inorganic filler, and the average particle size of the filler is <30 μm, in particular <20 μm, particularly preferably from 5 μm to 10 μm, and where the proportion of the inorganic filler present in the reactive composition is >50% by weight. The reactive composition may thus be used for the production of plastics moldings.

The d90 value of the at least one filler here is, in particular, 50 μm or less, in particular 30 μm or less, particularly preferably 25 μm or less. The d95 value of the at least one filler in a reactive composition is preferably 60 μm or less, in particular 45 μm or less, particularly preferably 35 μm or less.

It is preferable that a reactive composition comprises no further fillers alongside the at least one inorganic filler.

In relation to the other properties of the reactive composition, reference can be made to the descriptions provided above, for example, with respect to any colorants and auxiliaries present, the nature of the at least one organic polymer component, the constitution of the reactive composition and the material nature of the at least one inorganic filler.

Experiments have shown that the process gives particularly good-quality results when using a reactive composition with the features mentioned. In the forming process there is practically no occurrence at all of any visible cracks.

As mentioned above, we provide a plastics molding, in particular, a plastics molding which is in essence a panel, which can be, or has been, produced by the process. This is preferably a worktop, a wall panel or a floor panel, in particular, for the kitchen sector, sanitary sector and trade-fair sector. The plastics molding can also take the form of a trough or basin, as mentioned above.

A plastics molding which is in essence a panel can be applied to a substructure known from the prior art (for example, composed of plywood, foamed glass; or polyurethane foam, or having a honeycomb structure), then forming by way of example the surface of a kitchen worktop.

The plastics molding comprises a matrix which can be produced from the at least one organic polymer component defined above, and into which the at least one inorganic filler has been embedded, preferably with uniform distribution.

The Moh hardness of the plastics molding is preferably at most 9, in particular, from 4 to 7, preferably from 5 to 7.

It is particularly preferable that the preferably uniform thickness of the plastics molding is from 2 mm to 15 mm, in particular from 4 mm to 8 mm. A particularly preferred thickness is about 6 mm.

A plastics molding which is in essence a panel can, in principle be produced with any desired dimensions, but its maximum length is preferably up to about 4.1 m and its maximum width is preferably up to about 1.3 m.

It is especially preferable that the plastics molding comprises at least one inorganic filler of average particle size <30 μm, in particular <20 μm, particularly preferably from 5 μm to 10 μm. It preferably comprises no further fillers alongside the at least one inorganic filler. In particular, it is in essence free from inorganic filler particles with particle size >250 μm. It preferably comprises exclusively inorganic filler particles of size <100 μm, in particular <50 μm.

The proportion of the at least one inorganic filler present in the plastics molding is >50% by weight (based on the total weight of the plastics molding). It is preferable that the proportion of the at least one inorganic filler is from 50% by weight to 85% by weight, in particular, from 60% by weight to 70% by weight.

Further features and advantages of the disclosure are apparent from the description below of representative examples. The individual features can in each case be realized alone or in groups in combination with one another, without exceeding the scope of the disclosure.

### Examples

Castable reactive compositions with the following constitution were produced:

### Formulation 1:

36.3% by weight of an organic polymer component (methyl methacrylate/polymethyl methacrylate, the proportion of polymer being about 25%)
0.7% by weight of a conventional crosslinking agent (trimethylolpropane trimethacrylate)
0.5% by weight of a conventional peroxidic catalyst (1:2 mixture of di(4-tert-butylcyclohexyl) peroxydicarbonate and dilauroyl peroxide)
61% by weight of a powdered quartz as inorganic filler (Silbond 3000MST, silanized quality)
0.1% by weight of an agent with thixotropic effect (hydrophobic silica)
0.2% by weight of a conventional mold-release agent (stearic acid)
1.2% by weight of a pigment (titanium oxide).

### Formulation 2:

35.4% by weight of an organic polymer component (methyl methacrylate/polymethyl methacrylate, the proportion of polymer being about 25%)
0.7% by weight of a conventional crosslinking agent (trimethylolpropane trimethacrylate)
0.5% by weight of a conventional peroxidic catalyst (1:2 mixture of di(4-tert-butylcyclohexyl) peroxydicarbonate and dilauroyl peroxide)
61% by weight of a powdered quartz as inorganic filler (Silbond 3000MST, silanized quality)
1.0% by weight of an agent with thixotropic effect (hydrophobic silica)
0.2% by weight of a conventional mold-release agent (stearic acid)
1.2% by weight of a pigment (titanium oxide).

### Formulation 3:

35.9% by weight of an organic polymer component (methyl methacrylate/polymethyl methacrylate, the proportion of polymer being about 25%)
0.7% by weight of a conventional crosslinking agent (trimethylolpropane trimethacrylate)
0.5% by weight of a conventional peroxidic catalyst (1:2 mixture of di(4-tert-butylcyclohexyl) peroxydicarbonate and dilauroyl peroxide)
61% by weight of a powdered quartz as inorganic filler (Silbond 3000MST, silanized quality)
0.5% by weight of an agent with thixotropic effect (Aerosil R812S)
0.2% by weight of a conventional mold-release agent (stearic acid)
1.2% by weight of a pigment (titanium oxide).

### Formulation 4:

28.55% by weight of an organic polymer component (methyl methacrylate/polymethyl methacrylate, the proportion of polymer being about 25%)
0.55% by weight of a conventional crosslinking agent (trimethylolpropane trimethacrylate)
0.4% by weight of a conventional peroxidic catalyst (1:2 mixture of di(4-tert-butylcyclohexyl) peroxydicarbonate and dilauroyl peroxide)
69% by weight of a powdered quartz as inorganic filler
0.1% by weight of an agent with thixotropic effect (hydrophobic silica)
0.2% by weight of a conventional mold-release agent (stearic acid)
1.2% by weight of a pigment (titanium oxide).

### Formulation 5:

33.80% by weight of an organic polymer component (methyl methacrylate/polymethyl methacrylate, the proportion of polymer being about 25%)
0.6% by weight of a conventional crosslinking agent (trimethylolpropane trimethacrylate)
0.5% by weight of a conventional peroxidic catalyst (1:2 mixture of di(4-tert-butylcyclohexyl) peroxydicarbonate and dilauroyl peroxide)
63.6% by weight of powdered corundum (silane-modified grade of Sepasil)
0.1% by weight of an agent with thixotropic effect (hydrophobic silica)
0.2% by weight of a conventional mold-release agent (stearic acid)
1.2% by weight of a pigment (titanium oxide).

All of the reactive compositions of formulations 1 to 5 have very good processibility. No settling of the filler was observed during processing.

The viscosities measured for the casting compositions were:
Formulation 1: 25 600 mPa·s at 20° C.
Formulation 2: 39 600 mPa·s at 20° C. (highly thixotropic composition)
Formulation 3: 22 800 mPa·s at 20° C.
Formulation 4: 46 100 mPa·s at 20° C.
Formulation 5: 34 500 mPa·s at 20° C.

The reactive compositions were charged to a compression mold, heated to about 30° C., for the manufacture of molded panels. The mold was then heated to a temperature of about 100° C. The cast moldings were permitted to harden under pressure at this temperature. Once the hardening and subsequent cooling of the molded panels was complete, the edge of the moldings was locally heated to about 150° C. and then bent by a pressure-forming process. The material was again cooled to give panels having a longitudinal edge deflected through an angle of 90°.

The forming process was problem-free and proceeded without any damage to the molded panels. The surface of the moldings revealed no visible cracks in the region of bending and required no downstream mechanical operations.

1-18. (canceled)

19. A process for producing plastics moldings, comprising:
forming a molding from a castable reactive composition comprising at least one organic polymer component and at least one inorganic filler, wherein the average particle size of the filler is <150 μm and the proportion of the inorganic filler present in the reactive composition is >50% by weight, based on the weight of the hardened molding;
hardening the molding; and,
after hardening, subjecting the molding to a forming process.

20. The process as claimed in claim 19, wherein at least one-sub-region of the hardened molding is heated in the forming process to temperatures above the T_{g} value of the at least one organic polymer component.

21. The process as claimed in claim 19, wherein the hardened molding in the forming process is heated to a temperature of from 100° C. to 250° C.

22. The process as claimed in claim 19, wherein the hardened molding is heated in the forming process in a heated press or by hot air.

23. The process as claimed in claim 19, further comprising, after hardening, subjecting the hardened molding to a forming process via bending and/or thermoforming.

24. The process as claimed in claim 19, wherein the castable reactive composition comprises an acrylic- and/or methacrylic-based organic polymer component.

25. The process as claimed in claim 19, wherein the castable reactive composition comprises polymethyl methacrylate (PMMA) as organic polymer component.

26. The process as claimed in claim 19, wherein the castable reactive composition comprises methyl methacrylate (MMA) as organic polymer component.

27. The process as claimed in claim 19, wherein the inorganic filler is selected from the group consisting of quartz, cristobalite and mixtures thereof.

28. The process as claimed in claim 19, wherein the proportion of the inorganic filler present in the reactive composition is from 50% by weight to 85% by weight, based on the weight of the hardened molding.

29. A reactive composition used in the process as claimed in claim 19, wherein the at least one inorganic filler has an average particle size of <30 μm.

30. The reactive composition as claimed in claim 29; wherein the d90 value of the at least one filler is 50 μm or less.

31. The reactive composition as claimed in claim 29, wherein the d95 value of the at least one filler is 60 μm or less.

32. The reactive composition as claimed in claim 29, having a viscosity in the range from 5 Pa·s to 60 Pa·s, at 20° C.

33. A plastics molding comprising a polymer matrix into which at least one inorganic filler has been embedded with uniform distribution produced by the process as claimed in claim 19.

34. The plastics molding as claimed in claim 33, having a Mohs hardness from 4 to 7.

35. The plastics molding as claimed in clam 33, having a uniform thickness from 2 mm to 15 mm.

36. The plastics molding, as claimed in claim 33, comprising at least one inorganic filler of average particle size <30 μm.
